(19) United States
(12) Patent Application Publication
(10) Pub. No.: US 2004/0064401 A1
(43) Pub. Date: Apr. 1, 2004

(54) Systems and methods for detecting fraudulent information

(75) Inventors: Ana Palaghita, Richmond, VA (US); John Polk, Richmond, VA (US); Frances Massey Henneberger, Glen Allen, VA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/256,145

(22) Filed: Sep. 27, 2002

(51) Int. Cl. G06F 17/60

(52) U.S. Cl. 705/38

(57) ABSTRACT

Methods, systems, and articles of manufacture consistent with embodiments of the present invention perform a fraud detection process that organizes collected documents into one of a set of categories based on selected variables and information included in the documents. Each category of documents has one or more category types, which in turn, are associated with at least one variable that is further associated with certain threshold limits. The fraud detection process identifies one or more category types that are indicative of fraud based on an analysis of threshold violations for each variable in each category type. Based on the results of the analysis, and possibly filtering logic, selected documents are extracted from the identified category types and targeted for fraud analysis that may include validating the information included in each extracted document.

### BACKGROUND OF THE INVENTION

1. Field of the Invention

Methods and systems consistent with the present invention relate to fraud detection. More particularly, such systems and methods relate to detecting fraudulent information in a plurality of documents.

2. Background and Material Information

The rise in white collar crime has taken its toll on practically all types of businesses. In addition to crimes committed by employees, such as embezzlement, businesses have also experienced financial loss from crimes committed by non-affiliated individuals, such as customers who commit fraud. Financial institutions are one type of business that has felt the burden from lost revenue due to fraud related crimes. For example, an individual may misrepresent information on an application for a financial account, such as a credit card application, to fraudulently obtain a financial product (e.g., a credit card). Once obtained, the individual may use the financial product to purchase goods and/or services without intending to pay the financial institution providing the product.

To address these problems, financial institutions have turned to fraud detection methodologies to help identify misrepresented information prior to providing a customer with a financial product, such as a credit card or a financial loan. These conventional methodologies usually screen individual financial account applications for inconsistencies in the information provided by an individual. For example, a financial account application may be screened to determine whether there are discrepancies in an individuals names, address, etc. Conventional fraud detection methods may also screen applications to identify multiple requests from a common applicant or address. Once an application is identified as including potentially fraudulent information, an operator from the financial institution may attempt to contact the applicant to verify the information included in the application.

Although conventional fraud detection methods may identify individual applications as being fraudulent, they are slow and lack the capability to identify fraud schemes that attack financial institutions on a larger scale, such as a fraud ring. A fraud ring is a misrepresentation scheme followed by a plurality of individuals. Each individual in a fraud ring provides one or more fraudulent applications to a financial institution. These fraudulent application may include one or more items of information that are the same, such as names, addresses, social security numbers, etc. In some instances, the similar items may not be accurate data, such as a name or address that does not exist. In other instances, the similar items may be identification data fraudulently obtained from person not included in the fraud ring. Financial institutions that do not identify such schemes before providing a financial account to one or more members of the fraud ring generally experience lost revenue due to the illegal use of the provided account(s).

Accordingly, there is a need for a fraud detection process that monitors and identifies multiple instances of fraudulent information to detect, for example, fraud rings.

### SUMMARY OF THE INVENTION

Methods and systems consistent with embodiments of the present invention enable the detection of fraud among a set of documents. In one embodiment a method is provided that collects a set of documents, each document including information associated with a customer entity. The method further includes selecting a variable that reflects a characteristic of customer entity information provided in a document. Additionally, the method may include assigning the set of documents to a category having at least one category type, where the category type is associated with the selected variable. A control limit may also be defined that reflects a rate of occurrence of the selected variable within the set of documents associated with the category type. The method may then filter the set of documents based on the control limit to identify possibly fraudulent information among the set of documents.

Both the foregoing general description and the following detailed description are exemplary and are intended to provide further explanation of the embodiments of the invention as claimed.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which certain embodiments of the present invention may be implemented;

FIG. 2 is a flowchart of an exemplary set up process consistent with an embodiment of the present invention;

FIG. 3 shows a block diagram of document categories consistent with an embodiment of the present invention

FIG. 4 is a flowchart of an exemplary fraud detection process consistent with an embodiment of the present invention;

FIG. 5 shows a block diagram of a monitoring table consistent with an embodiment of the present invention; and

FIG. 6 shows an exemplary graphical interface consistent with an embodiment of the present invention.

### DETAILED DESCRIPTION

The present invention is directed to methods, systems, and articles of manufacture for filtering and analyzing a plurality of documents to detect fraudulent information provided therein. Methods, systems, and articles of manufacture consistent with embodiments of the present invention perform a fraud detection process that organizes collected documents into categories based on selected variables and information included in the documents. Each category of documents includes one or more category types, which in turn, include one or more variables with certain threshold limits. The fraud detection process identifies one or more category types that may be more likely to include fraudulent documents based on an analysis of threshold violations for each variable of every category type. Based on certain filtering rules, selected documents are extracted from the identified category types and targeted for final fraud detection processing to validate the information included in each extracted document.

Embodiments of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and aspects of these processes may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instructions or program code for performing various computer-implemented operations based on the methods and processes of the invention. The instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

Reference will now be made in detail to the invention, examples of which are illustrated in the accompanying drawings. Wherever possible, the same reference numbers will be used throughout the drawings to refer to the same or like parts.

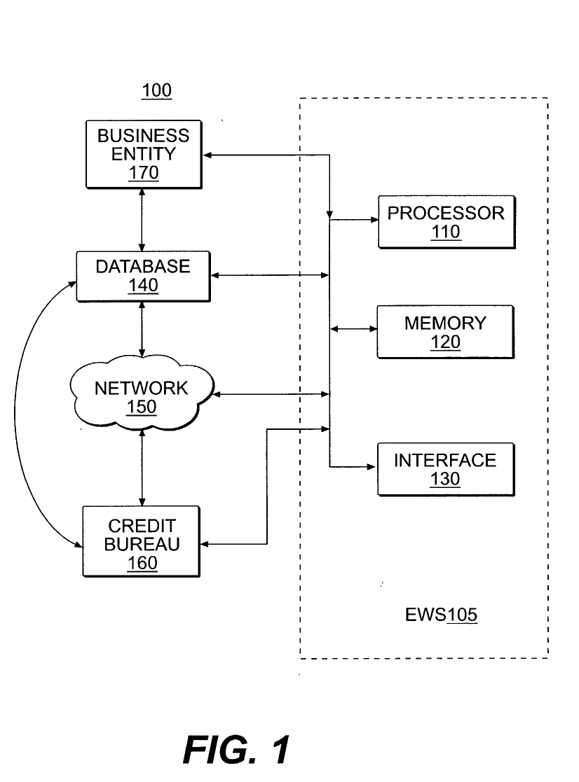

FIG. 1 illustrates an exemplary system environment 100 in which embodiments of the invention may be implemented. As illustrated in FIG. 1, environment 100 includes an Early Warning System (EWS) 105, database 140, network 150, credit bureau 160, and business entity 170.

EWS 105 may be a computing system that processes documents to determine whether fraudulent information is included in one or more of the documents. The expression “document,” as used herein, may represent any type of electronic or physical-based objects that includes, or is associated with, information provided by one or more customer entities. A customer entity may be an individual, a group of individuals, a business of entity, or a group of business entities. Although the following description of certain embodiments of the present invention may refer to an “individual,” one skilled in the art would appreciate that the same description applies to a customer entity in the manner described above. In one embodiment of the invention, a document represents an application for a financial account that includes a plurality of fields that are completed by an individual (e.g., name, social security number, address, etc.).

As shown in FIG. 1, one embodiment of EWS 105 includes a processor 110, memory module 120, and interface module 130. Processor 110 may be one or more processor devices known in the art, such as a microprocessor, laptop computer, desktop computer, workstation, mainframe, etc. Memory module 120 may represent one or more storage devices that maintain information that is used by processor 110 and/or other entities internal and external to EWS 105. Interface module 130 may be one or more devices that facilitate the transfer of information between EWS 105 and external components, such as database 140 and network 150.

Database 140 may represent one or more storage devices and/or systems that maintain data used by elements of computing system 100. Database 140 may include one or more processing components (e.g., storage controller, processor, etc.) that perform various data transfer and storage operations consistent with certain features related to the present invention. In one embodiment, database 140 stores documents received from individuals applying for services and/or products offered by business entity 170, such as a financial account provided by a financial institution. Database 140 may request the documents from another source, such as a financial institution data source, or may automatically receive the documents from the source. Further, database 140 may provide the documents to EWS 105 in response to a request. Alternatively, database 140 may automatically send the documents to EWS 105 at periodic or random intervals.

Network 150 may be any type of network that facilitates communications and data transfer between database 140, credit bureau 160, and EWS 105. Network 150 may be a Local Area Network (LAN), a Wide Area Network (WAN), such as the Internet, and may be a single network or combination of networks. Further, network 150 may reflect a single type of network, a combination of different types of networks, such as the Internet and public exchange networks for wireline and/or wireless communications. One skilled in the art would recognize that network 150 is not limited to the above examples and that computing environment 100 may implement any type of network that allows the entities (and others not shown) included in FIG. 1 to exchange data.

Credit bureau 160 may be any entity that generates, maintains, and provides credit information associated with one or more individuals, groups of individuals, business entities, and groups of business entities. For example, credit bureau 160 may represent well known credit service bureaus that generate a credit report for an individual based on that individual's employment history, housing status, credits, assets, debts, etc., such as TRW/Experian, Equifax, TransUnion, or a similar commercial credit service. Credit bureau 160 may provide credit related information associated with one or more individuals to a requesting entity, such as database 140 and EWS 105, either directly or indirectly through network 150.

Business entity 170 may represent an entity that provides services and/or products. In one embodiment, business entity 170 may provide products and/or services based on requests received from one or more individuals, or other business entities. The requests may be received in the form of the documents that are stored in database 140. Further, business entity 170 may execute EWS 105 to perform fraud detection processes consistent with certain embodiments of the invention. Alternatively, business entity 105 may request the services of EWS 105 from another business entity that markets the fraud detection and monitoring services performed by EWS 105 as described herein.

Although FIG. 1 shows the configuration of entities 105, 140, and 170 as separate elements, one skilled in the art would realize that system 100 may be implemented in a number of different configurations without departing from the scope of the present invention. For example, EWS 105, database 140, and/or business entity 170 may operate in a single system that includes software, hardware, and/or a combination of both, that perform processes consistent with certain embodiments of the present invention. Further, although EWS 105 is shown in FIG. 1 as including separate modules 110-130, one skilled in the art would appreciate that these modules may be configured as a single module that performs functions similar to those performed by modules 110-130 collectively. Alternatively, system 100 may be configured as a distributed system, with modules 110-130 distributed in remote locations and interconnected by communication paths, such as Local Area Networks (LANs), Wide Area Networks (WANs) and any other type of network that may facilitate communications and the exchange of information between modules 110-130 and/or any other elements that may be implemented by system 100. Also, system 100 may include additional or fewer modules than those depicted in FIG. 1 without departing from the scope of the present invention.

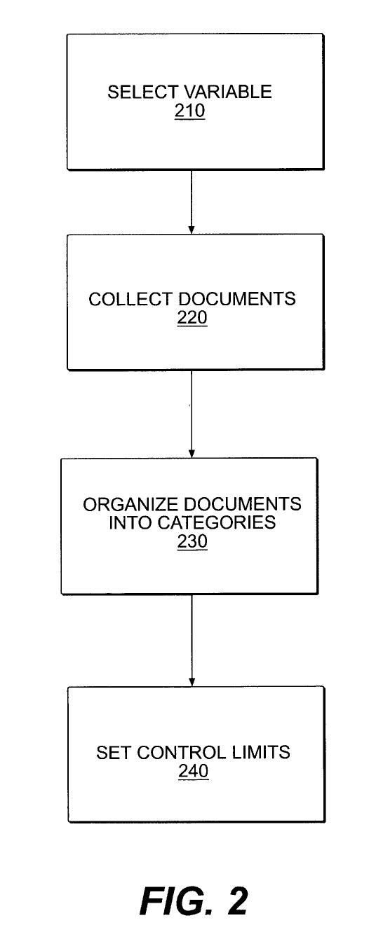

In one embodiment of the invention, exemplary system 100 may be configured to collect, filter, and analyze documents from database 140 to detect fraudulent information included in one or more of the documents. FIG. 2 shows a flowchart of an exemplary set up process that may be performed by EWS 105 consistent with an embodiment of the present invention. Although FIG. 2 is described below with documents associated with applications for a financial account, one skilled in the art would appreciate that the following description is applicable to any type of document. In one embodiment of the invention, EWS 105 performs the set up process by selecting one or more variables that are associated with the type of document that is being monitored by EWS 105 (Step 210). For example, a document, such as a financial account application, may include a plurality of fields corresponding to queries for an applicant to complete. The fields may request contact information (e.g., addresses, phone numbers, name, etc.), employment information (e.g., income, employer's name, etc.), financial information (e.g., financial accounts, debts, assets, etc.), and other types of information that may be used by business entity 170 to process the documents (e.g., approve or deny a credit application).

In one embodiment, EWS 105 may select variables by associating certain fields in a document with fraud related characteristics. For example, EWS 105 may select the following types of variables: mismatches or inconsistencies of, names, social security numbers, addresses, phone numbers, electronic mail addresses, employment history, financial accounts, utility accounts, etc. Additionally, EWS may select variables based on internal decisioning rules, such as correlations between certain fields of a document. For example, the age of an applicant compared to the age of an account corresponding to the applicant, such as a mortgage, credit card account, etc., may be selected as a variable by EWS. Therefore, EWS 105 may define a variable that targets a document that includes a 70 year old applicant who has had a checking account for only one year. Also, variables may be selected based on alerts from credit bureau 160. For example, variables based on credit bureau alerts may include detected mismatches between social security numbers, addresses, names, phone numbers, and other forms of questionable information, such as social security numbers that have corresponding requested death claims. EWS 105 may use the types of alerts provided by credit bureau 160 as variables in a manner consistent with certain embodiments of the present invention. Accordingly, a variable may be associated with characteristics of customer entity information included in a document. The characteristics may represent inconsistencies or misrepresentations of data included in the document. Alternatively, the characteristics may represent a type of activity associated with a customer identified in the document, such as whether the customer requested a balance transfer between financial accounts, etc.

In addition to selecting variables, EWS 105 may also collect information from each document stored in database 140 (Step 220). In one embodiment, EWS 105 collects the document information periodically from database 140 (e.g., daily, weekly, monthly, etc.). Further, EWS 105 may arrange the collected document information in a data structure that correlates selected fields with one or more of the variables selected in Step 210. The data structure may be a table, array, or similar data configuration that enables EWS 105 to process the data included therein in a manner consistent with certain embodiments of the present invention.

EWS 105 may use the collected document information to organize each document (e.g., application) into one or more predetermined categories (Step 230). A category is a grouping that business entity 170 and/or EWS 105 may determine based on the types of customers, documents, etc. associated with the entity 170. EWS 105 may organize the documents into categories to facilitate fraud detection processing. For instance, allowing EWS 105 to separate documents into discernable groups enables the system to target and process particular types of documents and individuals associated with each document. Further, categorizing the documents allows EWS 105 to apply selected decisioning rules that may be dedicated to a particular category or categories.

Each category may include one or more category types. Further, each category type may be associated with one or more variables included in the set of variables selected in Step 210. For example, EWS 105 may organize certain collected documents into a Line of Business (LOB) category. A LOB category is associated with a type of business unit that provides the document to business entity 170 (e.g., requesting a financial account through a credit application form). The LOB category may include several types of businesses, such as a small business type and a superprime type (e.g., a business with outstanding credit and business history)). Each LOB type also includes one or more variables, such as credit alerts, name mismatches, etc.

Further, or alternatively, EWS 105 may organize certain collected documents into a channel category that is associated with various mediums used by business entity 170 to acquire a customer (e.g., individual or business entity). For example, types of channels may include telephone, electronic, or paper-based mediums (e.g., conventional mail mediums). Other non-limiting examples of categories may include a geography category that includes segmented geographical areas, such as zip codes, area codes, etc., and combination of categories, such as a LOB versus channel category that includes category types reflecting mediums for each LOB type that was acquired by business entity 170 (e.g., small businesses that were obtained using electronic mediums, superprime businesses obtained using in person solicitations). One skilled in the art would realize that many different categories with one or more different category types may be implemented without departing from the scope of the present invention.

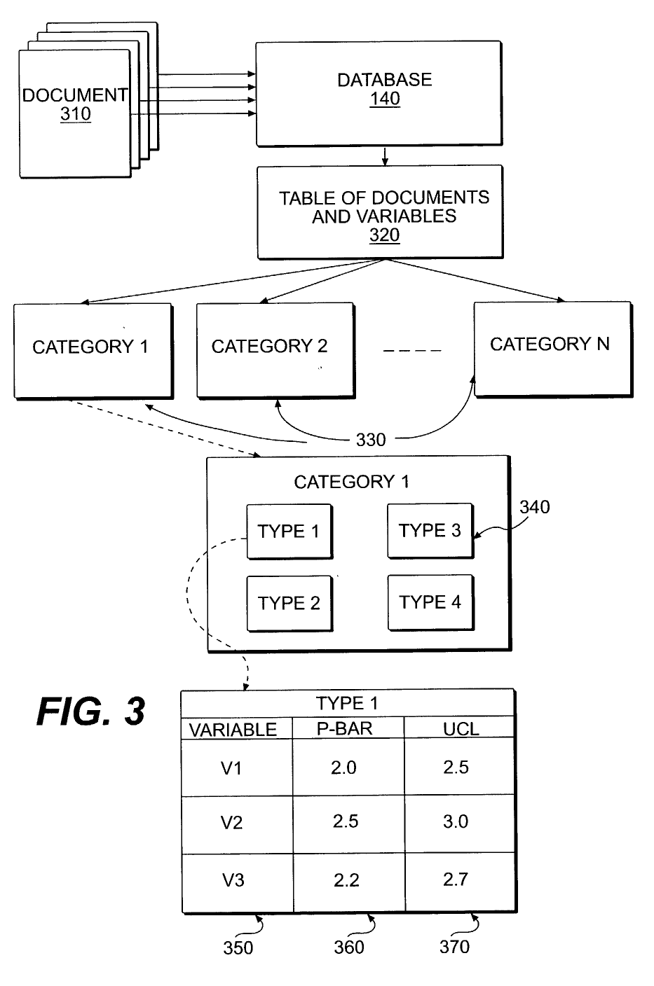

FIG. 3 shows an exemplary block diagram of the processes performed in Steps 210-230 of FIG. 2. As shown, documents 310 are received by database 140, which corresponds to database 140 illustrated in FIG. 1. The documents 310, or their information, is provided to EWS 105 and arranged into an exemplary table 320 that correlates the documents and the variables selected in Step 210 of FIG. 2. Using the information in table 320, EWS 105 may organize the documents into one or more categories 330, with each category including one or more category types 340. Each category type 340 may be associated with one or more variables 350. As shown in FIG. 3, exemplary category type1 includes three variables V1-V3.

Returning back to FIG. 2, EWS 105 may set control limits 360, 370 for each variable 350 included in a category type 340 (Step 240). In one embodiment, EWS 105 may set the control limits for each variable based on historical data for the corresponding variable. For example, EWS 105 may determine based on historical data, that every week, roughly 10% of the population (i.e., collected documents 310) includes a social security mismatch. Accordingly, EWS 105 may determine an average value, known as a “P-Bar value,” that represents an average number of occurrences, or “hits”, for a corresponding variable over a predetermined period of time. Therefore, in the above example, the P-Bar value for the social security mismatch variable would be 10%. Further, based on the determined P-Bar value, EWS 105 may also determine an Upper Control Limit (UCL) that represents a threshold value of hits for a corresponding variable. For example, based on the exemplary 10% average hit value for social security matches, EWS 105 may determine that the UCL for social security mismatches is 15%. Accordingly, a category type that experiences a percentage of hits above the UCL may be considered by EWS 105 as a target for fraud detection processing, which is described later. FIG. 3 shows exemplary P-Bar and UCL values (360 and 370, respectively) for variables V1-V3 of category type1. EWS 105 may configure and store the P-Bar and UCL information for each category type 340 of each category 330 in memory 120 or in another memory device located within or remotely to EWS 105.

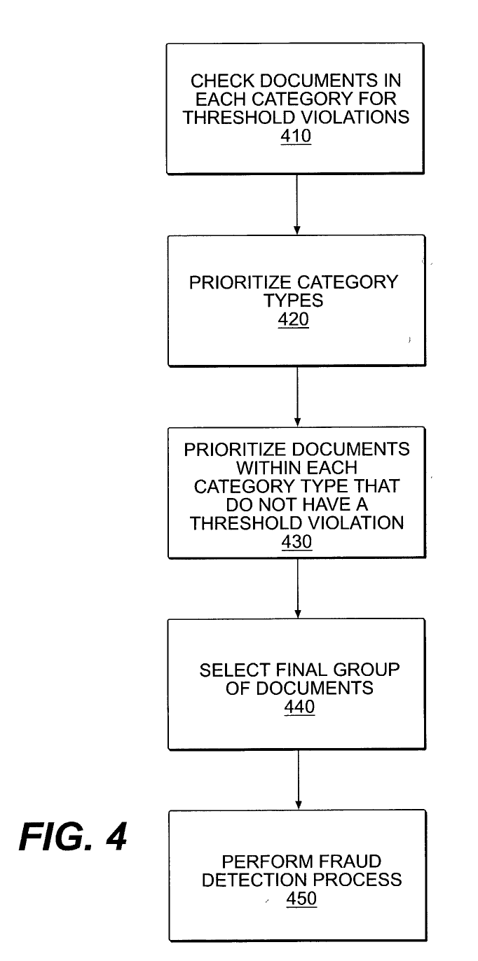

As described, EWS 105 may configure and maintain data structures reflecting categories of documents received from database 140. Once the categories are defined and the corresponding variables and control limits are defined, EWS 105 may filter the documents included in each category to facilitate fraud detection processes. FIG. 4 shows a flowchart of an exemplary fraud detection process consistent with certain embodiments of the present invention.

The fraud detection process may begin with EWS 105 collecting documents from database 140 as described above with respect to Step 220 of FIG. 2. EWS 105 may collect documents periodically, such as daily, weekly, etc. Once collected, EWS 105 determines whether the information in each document 310 for each selected category 330 includes information that causes a “hit” on one or more variables 350 within each category type 340 (Step 410). For example, EWS 105 may check each document to determine whether it has a social security mismatch, a name mismatch, etc. Further, EWS 105 may poll credit bureau 160 to determine whether there any mismatch alerts for the information included in each document.

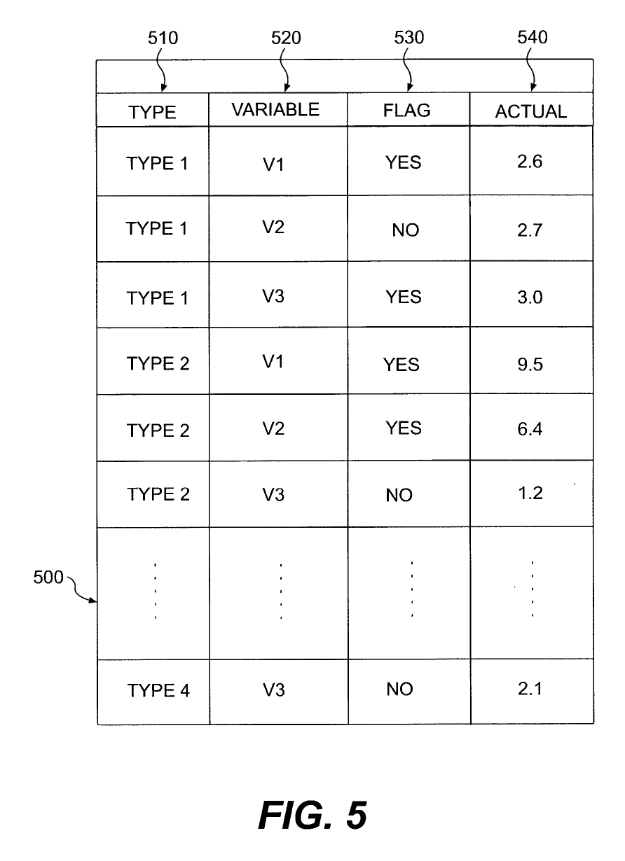

In one embodiment, EWS 105 may track the number of hits received for each variable 350 in every category type 340. EWS 105 may then create and maintain a data structure that represents a correlation between the variables 350 for each category type 340 and a monitored variable hit rate value reflecting a number of hits detected for a variable in each category type (i.e., whether any documents included in the category type 340 includes information, such as an address mismatch, that represents a particular fraud activity). FIG. 5 shows a block diagram of an exemplary data structure 500 that may be created by EWS 105 and stored in a memory device, such as memory 120, consistent with an embodiment of the present invention. As shown in FIG. 5, data structure 500 includes information showing a relationship between one or more category types 510, the variables 520 included in the category type, an indication 530 of whether the monitored hits of each variable exceeded the UCL value for that variable, and an actual hit rate value 540 for each variable in a category type 510. In the exemplary data structure 500, EWS 105 determined the number of monitored hits for the first and third variables of category type1 of category1 have exceed their corresponding UCL values. For instance, 2.6% of the population of documents included in type1 of category1 that were received by EWS 105 over the predetermined period of time were determined to have attributes causing a hit for variable V1. Further, 3.0% of the population of documents included in type1 of category1 were determined to have attributes causing a hit for variable V3. Because the exemplary UCL for variables V1 and V3 in type 1 of category 1 is 2.5% and 2.7%, respectively (see FIG. 3, elements 350-370), EWS 105 may flag these two variables for further fraud detection because the monitored hit rates for these variables exceeds their corresponding UCLs (e.g., “YES” in indication column 530).

In addition to identifying the variables that have exceeded their corresponding threshold values (e.g., UCL), EWS 105 may also filter the document population within each category 330 based on one or more filtering rules (Step 420). In one embodiment, EWS 105 may filter the documents in a category 330 by first identifying which category types 340, if any, do not have any variables that are statistically out of bounds (i.e., variables that have exceeded their corresponding UCL). For example, EWS 105 may have defined twelve types for an exemplary category, such as an LOB category. However, only ten of the twelve category types may have one or more variables exceeding their UCL value (i.e., out of bounds variables). Accordingly, EWS 105 filters the two types of the exemplary category that do not include out of bounds variables such that they are not further considered by EWS 105 for additional fraud detection processing.

Once EWS 105 has identified and removed any category types from consideration, the remaining types, if any, may be further filtered. In one embodiment, EWS 105 may apply one or more filtering rules to identify those category types that should be considered for fraud detection processing. A filtering rule may be logic that is applied by EWS 105 to identify category types that show tendencies for fraud more than other category types. For example, EWS 105 may apply a filtering rule that considers the percentage difference between an actual monitored variable hit rate value and the variable's UCL. If the percentage difference is above a predetermined threshold (e.g., 20%), EWS 105 may determine that the category type that includes the subject variable is worthy of additional fraud detection processing. However, if the percentage difference for every variable of a category type is below their corresponding thresholds, that type is filtered by EWS 105 and is not further considered for additional fraud detection processing. The threshold value for each variable may be based on characteristics of the variable, the category type, and/or the category associated with the variable. Therefore, each threshold value for each variable may be different or the same as for other variables.

One skilled in the art would appreciate that other filtering rules may be implemented without departing from the scope of the present invention. For example, EWS 105 may filter category types from fraud detection processing based on the number of variables out of bounds. Therefore, if a category type has only one variable out of bounds, and the type includes seven variables, EWS 105 may determine that the type is not to be the target for further fraud detection processing. Alternatively, if a category type has a four variables out of bounds, and the category type includes the seven variables, EWS 105 may identify that category type as worthy of additional fraud detection processing. EWS 105 may combine selected filtering rules as well. For example, in addition to considering the number of variables out of bounds for a category type, EWS 105 may take into account the percentage difference between an out of bounds variable's monitored hit rate and the variable's corresponding UCL. Therefore, although the above exemplary category type may have four out of seven variables that have exceeded their UCLs, EWS 105 may filter the category type from additional fraud detection processing if the percentage difference for each variable is below their corresponding predetermined threshold.

In addition to filtering category types, EWS 105 may also filter entire categories based on the filtering rules. For example, if a category includes a certain number of category types that include out of bounds variables, EWS 105 may identify that category as worthy of additional fraud processing. If, on the other hand, the category does not include the certain number of category types with out of bounds variables, EWS 105 may identify the category as not worthy of additional fraud detection processing. Alternatively, EWS 105 may also consider combination of filtering rules when filtering entire categories. For example, a category that includes only one category type with only one variable out of bounds may be considered as worthy of additional fraud detection processing based on the percentage difference between that variable's UCL and monitored hit rate value. For example, an exemplary category that includes a single category type with a single variable having a percentage difference value equal to 250% may be recognized by EWS 105 as a category that should be scrutinized further in accordance with certain embodiments of the present invention.

One skilled in the art will appreciate that EWS 105 may implement many different filtering rules based on various characteristics associated with each document, business entity 170, category 330, and category type 340, without departing from the scope of the present invention. For example, EWS 105 may implement filtering rules that consider category types 340 that include a certain number of documents that meet predetermined criteria. For example, if the documents are financial account applications, EWS 105 may filter category types 340 that include a certain number of documents that are associated with credit limits above or below a selected value (e.g., average credit limit for a set of documents included in a category type 340 is above $300).

Once the appropriate category types 340 from each category 330, or entire categories 330, are filtered based on, for example, one or more filtering rules, EWS 105 may analyze the documents 310 within each remaining category type. In one embodiment, EWS 105 may filter each document that does not have a variable out of bounds from each category type 330 (Step 430). For example, a category type 330 that survived the filtering process in Step 420 and includes 100 documents may be analyzed by EWS 105 to remove those documents that do not have a variable hit. For instance, if out of 100 documents in the exemplary remaining category type 340, only 70 documents correspond to a variable out of bounds (e.g., had one or more variable hits), those 70 documents will be considered for additional fraud detection processing while the remaining 30 documents will be removed from consideration.

Following the filtering of documents in each category type 340, EWS 105 may select a final group of documents for fraud detection processing (Step 440). In one embodiment of the present invention, EWS 105 may select the final group of documents using an automated ring search process. This process allows EWS 105 to apply one ore more ring search rules to eliminate documents that are not considered target documents for fraud processing. EWS 105 may implement ring search rules that are defined based on historical knowledge of fraud rings. For example, business entity 170 may have determined through historical analysis that fraud rings are typically associated with documents that include repeated field information. That is, multiple documents that include the same name, social security number, addresses, e-mail addresses, employment information, etc. may be associated with a single fraud ring. EWS 105 may take into account this historical information to implement a filtering rule that identifies one or more documents including the same field information.

EWS 105 may also filter certain documents from the identified documents based on status filtering rules. For example, EWS 105 may implement a status filtering rule that determines whether a set of documents including one or more common field information (e.g., the same last name, same home address, etc.) also includes other field information that may reflect a certain status of the individuals associated with these documents. For example, a husband and a wife may legitimately apply for a financial account within the same week of each other. Because these two individuals may have the same address and last name, EWS 105 may process a status filtering rule that checks the social security number for each individual. If the numbers are different, EWS 105 may consider the two individuals as spouses and remove them from further fraud detection processing. On the other hand, if the social security numbers are the same, these documents may be considered potential fraudulent and worthy of additional fraud detection processing. EWS 105 may apply different types of status filtering rules that identify a status of an individual associated with a document. For example, EWS 105 may implement a status filtering rule that determines whether an individual identified in a document is a student. Because college students have tendencies to have common addresses (e.g., students may live in a dormitory or a fraternity/sorority house) EWS 105 may eliminate these documents from consideration. However, EWS 105 may also implement a threshold value of documents that include common field information before determining that a potential fraud problem exists. For example, EWS 105 may determine that five documents associated with five students with different last names and a common address are not worthy of additional fraud detection processing. However, ten documents associated with 10 different students and a common address may warrant further fraud detection processing. Accordingly, EWS 105 may implement a number of different status filtering rules for removing documents identifying legitimate customers from additional fraud detection processing.

As described above, EWS 105 may select a final group of documents using an automated ring search process. In another embodiment, EWS 105 may select a final group of documents using a weighted score approach. In this embodiment, EWS 105 implements a weighting process that correlates score values to each document based on selected characteristics associated with the document. For example, in one approach, EWS 105 may score documents based on the type of variable mismatch. That is, those variables associated with credit bureau reports may automatically be identified as worthy of additional fraud detection processing and thus a higher score value in an embodiment where higher score values represent a higher likelihood of fraud. Alternatively, EWS 105 may score documents based on the number of variable hits. Therefore, a document with five variable hits (e.g., social security mismatch, name mismatch, address mismatch, credit bureau report mismatch, etc.) may have a higher score than that of a document with only one variable mismatch. One skilled in the art would realize the value of the score may be based on how the scoring process is implemented by EWS 105. That is, a low or a high score may reflect fraudulent activity without departing from the scope of the present invention.

Alternatively, instead of the static scoring approach described above, EWS 105 may implement a variable scoring approach. For example, EWS 105 may score documents based on the number of variables hit and the gravity of each variable. The gravity of a variable may be determined by business entity 170 or EWS 105 based on the type of documents processed. For instance, a social security mismatch variable may have more weight as a fraudulent activity than an e-mail mismatch since people tend to change their e-mail addresses due to moving or changing jobs. Accordingly, EWS 105 may access a data structure that ranks each variable selected in Step 210 and applies the rank value for scoring each document. Further, EWS 105 may consider the average percentage difference between a monitored variable hit rate and a corresponding UCL for a variable in a category type 330 to determine a document's score. Thus, a document with a variable hit rate that has a higher percentage difference than another document will receive a score that is more representative of fraudulent activity.

Whether using the static or variable scoring approach, EWS 105 may analyze the scores for the documents to determine which, if any, documents are more worthy of additional fraud detection processing than other documents. For example, EWS 105 may select documents with a top 10% of score values (e.g., documents with the highest 10% score values). These selected documents are included in the final group for fraud detection processing.

Referring back to FIG. 4, EWS 105 may perform final fraud detection processing on the documents included in the final group (Step 450). In one embodiment, EWS 105 may execute a process that generates a graphical interface for a user. Based on the information included in each of the documents of the final group, EWS 105 may configure the interface to present information for review by a user. For example, the interface may include a window that presents the name, social security number, address, and personal information associated with each individual included in the documents of the final group. A user may use this information to contact, or attempt to contact, each individual listed in the window to validate or invalidate their corresponding document. Additionally, EWS 105 may configure the interface with a template that includes fields that the user may provide information associated with the progress of the fraud detection process.

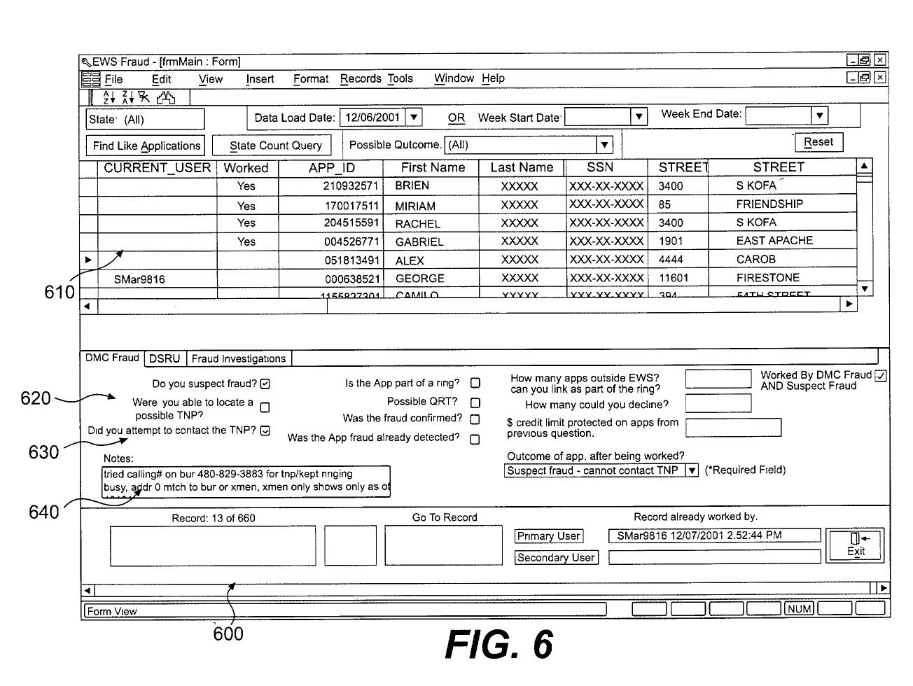

FIG. 6 shows an exemplary graphical interface 600 that may be generated by EWS 105 consistent with an embodiment of the present invention. As shown, interface 600 may include a window 610 that includes contact information for each individual identified in the documents included in the final group. Further, interface 600 may include a template 620 with query boxes 630 that are checked by a user during manual fraud detection processing. Further, interface 600 may also include a window 640 for notes the user may enter to described the status of the progress of the fraud detection process. EWS 105 may collect the information provided by one or more users that provide information to EWS 105 through interface 600 and generates a progress report for fraud detection operations. The report may indicate the number of documents detected that include verified fraudulent information, the number of fraud rings, if any, detected, the monetary loss associated with each detected fraud ring, and the future funds protected based on the ring's detection. One skilled in the art would appreciate that the progress report and interface generated by EWS 105 may include a number of different information and are not limited to the exemplary data described above.

EWS 105 may also implement an automated fraud detection process that automatically verifies the documents included in the final group. For example, in one embodiment, EWS 105 may perform an analysis process that analyzes the information included in each final document to determine whether the information included therein is valid. EWS 105 may perform a process that automatically generates electronic messages, such as e-mails, electronic voice messages, etc., and/or paper-based messages that include a request for verification of information. For example, a message may request that an individual contact business entity 170 to discuss the information included in a document associated with their name. These messages may be provided to the individuals using appropriate mediums (e.g., the Internet, conventional mail services, wireline or wireless networks, etc.). If an individual does not respond to a request included in a delivered message before a predetermined period of time, EWS 105 may determine that the document corresponding to the non-responsive individual is fraudulent.

EWS 105 may handle a verified fraudulent document based on the type of business the documents are associated with, such as the type of business associated with business entity 170. For instance, in a financial account scenario, the documents may represent loan or credit card applications. An application that is determined to be fraudulent by EWS 105 may be denied and forwarded to government authorities for possible criminal investigation. Accordingly, EWS 105 and/or business entity 170 may determine how a fraudulent document is handled once verified.

As described, embodiments of the present invention enable a system to filter a set of received documents to identify one or more documents that are more likely to be representative of a fraud ring, or is associated with fraudulent information. Although the present invention is described with respect to financial account documents, one skilled in the art would appreciate that the invention may be applied to other areas without departing from the scope of the present invention. Further, the present invention is not limited to the exemplary configuration and sequence of steps illustrated in FIGS. 2 and 4. That is, EWS 105 may perform the steps in FIGS. 2 and 4 in various sequences without departing from the scope of the invention.

Further, the processes described with respect to FIG. 2 may be performed prior to collecting any documents from database 140. For example, in one embodiment of the present invention, EWS 105 may select variables and define categories, with category types and variables, based on historical data associated with the types of documents that are collected in database 140. Accordingly, the categories, category types, UCLs, P-Bars, other threshold values, and variables may be predefined prior to collecting documents from database 140. Alternatively, or additionally, EWS 105 may adjust, remove, and/or add a predefined category, category type, UCL, P-Bar, other threshold values, and/or variable, based on documents received from database 140. For instance, a P-Bar value for a exemplary variable may be defined based on historical data associated with the type of fraudulent customer entity information associated with the variable. However, EWS 105 may adjust the P-Bar value, and/or a UCL, based on updated statistical data associated with variable hits in newly received and analyzed documents.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. Furthermore, although embodiments of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents.

What is claimed is:

1. A method for detecting fraud among a set of documents, the method comprising:
collecting a set of documents, each document including information associated with a customer entity;
selecting a variable reflecting a characteristic of customer entity information provided in a document;
assigning the set of documents to a category type associated with the selected variable;
defining a control limit reflecting a predetermined rate of occurrence of the selected variable within the set of documents associated with the category type; and
filtering the set of documents, based on a determination that the control limit is exceeded to detect possibly fraudulent information.

2. The method of claim 1, wherein the characteristic is associated with a type of misrepresented customer entity information.

3. The method of claim 1, wherein assigning the set of documents to a category comprises:
assigning a document from the set to a particular category based on the customer entity information provided in the document.

4. The method of claim 1, wherein defining a control limit comprises:
determining the control limit for the variable based on an average rate of occurrence of the characteristic of customer entity information associated with the variable within the set of documents.

5. The method of claim 1, wherein each document is an application for a financial account provided by at one of a business entity and an individual.

6. A method for detecting fraudulent information among a set of documents, wherein each document in the set of documents includes customer entity information and is assigned to a category, and wherein the documents assigned to the category are further assigned to one of a plurality of category types, each category type having a variable associated with a characteristic of the customer entity information, the method comprising:
determining, for each category type, whether the respective variable exceeds a predetermined control limit;
identifying any category type that may indicate fraud based on a determination that the respective variable for that category type exceeds the predetermined control limit;
filtering those documents assigned to an identified category type identified for fraud; and
analyzing the filtered documents to determine whether they may include fraudulent information.

7. The method of claim 6, wherein the predetermined control limit reflects a certain number of documents included in the category type that include the characteristic of customer entity information corresponding to the variable.

8. The method of claim 6, wherein identifying any category types that may indicate fraud further includes:
determining, for each variable in each category type, a difference value between a number of documents in the respective category type that include the characteristic of customer entity information corresponding to the variable and a control limit for the variable.

9. The method of claim 8, wherein identifying any category types that may indicate fraud further comprises:
designating a category type as indicative of fraud when its corresponding variable has a difference value above a predetermined threshold value associated with the corresponding variable.

10. The method of claim 6, wherein filtering those documents assigned to an identified category type further comprises:
selecting a final group of documents from the identified documents based on a type of customer entity provided in each of the identified documents.

11. The method of claim 6, wherein filtering those documents assigned to an identified category type further comprises:
for each of the identified documents,
removing the identified document from a final group of documents based on a determination whether a customer entity provided in the identified document is one of a spouse, sibling, parent, or child of another customer entity identified in another document included in the identified documents.

12. The method of claim 6, wherein filtering those documents assigned to a category type further comprises:
for each of the identified documents,
removing the identified document from a final group of documents based on whether a customer entity included in the identified document is a student.

13. The method of claim 12, wherein removing the identified document further includes:
removing the identified document from the final group based on whether (i) a customer entity included in the identified document is a student and (ii) an address included in the identified document is the same as addresses included in a certain number of other of the identified documents.

14. The method of claim 6, wherein analyzing the filtered documents includes:
for each filtered document,
contacting a customer entity identified in the document to verify the customer entity information included in the document.

15. The method of claim 6, wherein analyzing the filtered documents includes:
generating a user interface that presents (i) the customer entity information for each filtered document and (ii) a template including one or more queries that are responded to by a user based on a progress of verifying customer entity information in a selected filtered document.

16. The method of claim 6, wherein identifying any category types that may indicate fraud includes:
for each category type,
determining that a category type is indicative of fraud based on a number of a plurality of variables that exceed the predetermined control limit for the category type.

17. The method of claim 6, wherein the predetermined control limit is reflects a certain number of the documents assigned to the category type that include the characteristic of customer entity information corresponding to the variable for the category type.

18. A system for detecting fraud among a set of documents, comprising:
a database for storing the set of documents, wherein each document includes customer entity information; and
a fraud detection system configured to:
receive the set of documents from the database,
assign the set of documents to a category, each category having a plurality of category types and wherein each document is further assigned to one of the plurality of category types, and where each category type is associated with a variable that corresponds to a characteristic of customer entity information, and
for each variable in each category type,
define a control limit reflecting a predetermined limit for a rate of occurrence of the variable within documents associated with the category type, and
detect fraud based on the rate of occurrence for the variable exceeding the control limit.

19. A system for detecting fraud among a set of documents, comprising:
a database for storing the set of documents, wherein each document includes customer entity information; and
a fraud detection system configured to:
assign the set of documents to a category, wherein the documents assigned to the category are further assigned to one of a plurality of category types, each category type having a variable associated with a characteristic of customer entity information,
determine, for each category type, whether the respective variable exceeds a predetermined control limit,
identify any category types that may indicate fraud based on a determination that the respective variable for that category type exceeds the predetermined control limit,
filter those documents assigned to an identified category type identified for fraud, and
analyze the filtered documents to determine whether they may include fraudulent information.

20. The system of claim 19, wherein the predetermined control limit reflects a certain number of documents included in the category type that include inconsistent customer entity information corresponding to the variable.

21. The system of claim 19, wherein the fraud detection system is further configured to:
determine, for each variable in each category type, a difference value between a number of documents in the respective category type that include the characteristic of customer entity information corresponding to the variable and a control limit for the variable.

22. The system of claim 21, wherein the fraud detection system is further configured to:
designate a category type as indicative of fraud when its corresponding variable has a difference value above a predetermined threshold value associated with the corresponding variable.

23. The system of claim 19, wherein the fraud detection system is further configured to:
selecting a final group of documents from the identified documents based on a type of customer entity provided in each of the identified documents.

24. The system of claim 19, wherein the fraud detection system is further configured to:
for each of the identified documents,
remove the identified document from a final group of documents based on a determination whether a customer entity provided in the identified document is one of a spouse, sibling, parent, or child of another customer entity identified in another document included in the identified documents.

25. The system of claim 19, wherein the fraud detection system is further configured to:
for each of the identified documents,
remove the identified document from a final group of documents based on whether a customer entity included in the identified document is a student.

26. The system of claim 25, wherein when the fraud detection system removes the identified documents, the system further removes the identified document from the final group based on whether (i) a customer entity included in the identified document is a student and (ii) an address included in the identified document is the same as addresses included in a certain number of other of the identified documents.

27. The system of claim 19, wherein the fraud detection system is further configured to:
for each filtered document,
contact a customer entity identified in the document to verify the customer entity information included in the document.

28. The system of claim 19, wherein the fraud detection system is further configured to:
generate a user interface that presents (i) the customer entity information for each filtered document and (ii) a template including one or more queries that are responded to by a user based on a progress of verifying customer entity information in a selected filtered document.

29. The system of claim 19, wherein the fraud detection system is further configured to:
for each category type,
determine that a category type is indicative of fraud based on a number of a plurality of variables that exceed the predetermined control limit for the category type.

30. The system of claim 19, wherein the predetermined control limit reflects a certain number of the documents assigned to the category type includes the characteristic of customer entity information corresponding to the variable for the category type.

31. A computer-readable medium including instructions for performing a method, when executed by a processor, for detecting fraud among a set of documents, the method comprising:
collecting a set of documents, each document including information associated with a customer entity;
selecting a variable reflecting a characteristic of customer entity information provided in a document;
assigning the set of documents to a category type associated with the selected variable;
defining a control limit reflecting a predetermined rate of occurrence of the selected variable within the set of documents associated with the category type; and
filtering the set of documents, based on a determination that the control limit is exceeded, to detect possibly fraudulent information.

32. A computer-readable medium including instructions for performing a method, when executed by a processor, for detecting fraudulent information among a set of documents, wherein each document in the set of documents includes customer entity information and is assigned to a category, and wherein the documents assigned to the category are further assigned to one of a plurality of category types, each category type having a variable associated with a characteristic of customer entity information, the method comprising:
determining, for each category type, whether the respective variable exceeds a predetermined control limit;
identifying any category type that may indicate fraud based on a determination that the respective variable for that category type exceeds the predetermined control limit;
filtering those documents assigned to an identified category type identified for fraud; and
analyzing the filtered documents to determine whether they may include fraudulent information.
